(19) United States
(12) Patent Application Publication
(10) Pub. No.: US 2021/0323189 A1
(43) Pub. Date: Oct. 21, 2021

(54) Portable Circular Saw

(71) Applicant: Robert Bosch GmbH, Stuttgart (DE)

(72) Inventors: Juergen WIKER, Stuttgart (DE); Thomas ZIEGLER, Steinheim An Der Murr (DE); Daniel DENNIS, Nuertingen (DE)

(21) Appl. No.: 16/625,572

(22) PCT Filed: May 30, 2018
(86) PCT No.: PCT/EP2018/064184

§ 371 Date: Dec. 20, 2019

(30) Foreign Application Priority Data
Jul. 3, 2017 (DE) 10 2017 211 270.0

(51) Int. Cl. B27G 19/04; B23D 45/16

(52) U.S. Cl. CPC B27G 19/04; B23D 45/16

(57) ABSTRACT

A portable circular saw has a sole plate, a housing, and a drive unit which is arranged at least partially in the housing and to which a tool receptacle for an interchangeable saw blade is assigned. The drive unit is configured to drive the interchangeable saw blade in rotation about an associated axis of rotation, and the portable circular saw is guidable along a workpiece by means of the sole plate. The saw further includes a securing device having at least one sensor element. The securing device is configured to detect at least one breaking of the portable circular saw into the workpiece during a sawing operation and, upon detecting any breaking into the workpiece, to brake and/or switch off the drive unit.

### PRIOR ART

The present invention relates to a portable circular saw having a sole plate, a housing, and a drive unit which at least in portions is disposed in the housing and which is assigned a tool receptacle for an interchangeable saw blade, wherein the drive unit is configured for rotatingly driving the interchangeable saw blade about an assigned rotation axis, and wherein the portable circular saw by means of the sole plate is guidable along a workpiece.

A circular saw, configured as a portable circular saw, which has a housing and a drive unit which in portions is disposed in the housing is known from the prior art. The drive unit herein is assigned a tool receptacle for an interchangeable saw blade, and the drive unit is configured for rotatingly driving the interchangeable saw blade about an assigned rotation axis.

DE 35 46 896 C2 furthermore discloses a method for detecting an imminent kickback state for increasing the operational safety in a motorized tool. The method is based on detecting a percentage change in the rotating speed of the motor. This results in an adequate sensitivity of the method in the case of high rotating speeds of the motorized tool, and excessive sensitivities are avoided in the case of low rotating speeds.

DE 10 2007 062 256 A1 furthermore discloses a circular saw having a saw blade that is rotatingly driven about a rotation axis, and at least a first riving knife. One embodiment of the circular saw herein is configured in such a manner that for increasing the operational safety at least the first riving knife by means of a servomotor is automatically movable relative to the rotation axis of the saw blade.

### DISCLOSURE OF THE INVENTION

The present invention provides a portable circular saw having a sole plate, a housing, and a drive unit which at least in portions is disposed in the housing and which is assigned a tool receptacle for an interchangeable saw blade, wherein the drive unit is configured for rotatingly driving the interchangeable saw blade about an assigned rotation axis, and wherein the portable circular saw by means of the sole plate is guidable along a workpiece. A safeguard device having at least one sensor element is provided, wherein the safeguard device is configured for detecting crashing of the portable circular saw into the workpiece, at least as arises in a sawing procedure, and upon detecting any crashing into the workpiece is configured for decelerating and/or switching off the drive unit.

The invention thus enables a reliable detection of a crashing of the portable circular saw into the workpiece, and preferably associated herewith an immediate deceleration and/or switching-off of the drive unit. Consequently, the operational safety can be significantly increased. Moreover, the end of a saw cut and a kickback, that is to say jamming of the saw blade in the workpiece, can be reliably detected by way of the safeguard device.

The term of so-called “crashing into” in the context of the present description is understood to be an at least partial braking or rupturing of the workpiece outside of the saw cut generated in the workpiece by means of the circular saw. The safeguard device can moreover be designed as a retrofit kit for usual standard portable circular saws or other sawing devices.

The sensor element preferably has at least one acceleration sensor. On account thereof, the safeguard device makes do without damage-prone components that are mechanically moved.

The sensor element preferably has at least one rotating speed sensor. A particularly simple construction of the required sensor mechanism is thus provided. The crashing of the portable circular saw into a workpiece explained above can be detected by way of a rapid increase in the rotating speed, for example, and the drive unit can be switched off and/or at least partially decelerated.

In the case of a technically favorable refinement, the sensor element has at least one electromechanical and/or one electronic switching means. A particularly robust sensor mechanism which at the same time is of simple construction can be implemented on account thereof. A switching means of this type can at the same time be comparatively easily repaired in the event of a defect.

The at least one switching means in the region of a rectangular passage opening of the saw blade is preferably disposed on a workpiece-facing bearing face of the sole plate. A reliable detection of any potential crashing of the portable circular saw is possible on account thereof.

According to one embodiment, the at least one switching means at least in portions runs in the region of at least one narrow side and/or at least in portions runs in the region of at least one longitudinal side of the passage opening. The detection of any potential crashing of the portable circular saw thus takes place in the direct vicinity of the saw cut.

According to one further embodiment, the at least one switching means is configured so as to be L-shaped, U-shaped, or rectangular. Various variants of design in terms of construction are provided on account thereof.

According to a further embodiment, the at least one switching means comprises the passage opening in the manner of a frame. Consequently, detecting is possible on all sides.

The at least one switching means in the case of the sole plate bearing on the workpiece preferably terminates so as to be flush with the bearing face of said sole plate and when raising the sole plate from the workpiece springs out of said bearing face. A safe and reliable integration of the safeguard device in the portable circular saw is thus provided.

The at least one switching means preferably has a spring-loaded rocker or pressure plate which is in particular configured for activating an electrical contact and/or a strain gauge of the switching means. A digital or analog signal for evaluating by means of a control apparatus of the safeguard device can thus be selectively provided by the switching means.

According to a further embodiment, the at least one sensor element has an optical detector. Consequently, a crashing procedure of the portable circular saw is possible in a non-contacting manner.

The at least one optical detector in the region of a passage opening of the saw blade is preferably disposed so as to be flush in a workpiece-facing bearing face of the sole plate. On account thereof, the detection thus takes place in the direct vicinity of the saw cut.

In the case of a technically advantageous refinement, the bearing face for configuring an area-measuring zone has at least one depression, wherein the at least one optical detector is disposed in the at least one depression. On account thereof, a planar detection of a crashing procedure is provided.

The at least one optical detector is preferably formed having an optical reflex sensor. A particularly compact construction is thus provided.

The safeguard device preferably has a control apparatus. On account thereof, the digital or analog signals supplied by the at least one sensor element can be comprehensively evaluated for detecting the crashing of the portable circular saw and for switching off the drive unit. The control apparatus can be implemented, for example, by way of a microcomputer embodied as an integrated circuit, or the like.

### BRIEF DESCRIPTION OF THE DRAWINGS

The invention is explained in more detail in the description hereunder by means of exemplary embodiments illustrated in the drawings in which:

FIG. 1 shows a schematic lateral view of a portable circular saw having a safeguard device;

FIG. 2 shows a diagrammatic illustration of the portable circular saw of FIG. 1, having a first embodiment of the safeguard device when crashing into a workpiece;

FIG. 3 shows a diagram of a rotating speed profile detected by a second embodiment of a safeguard device, for detecting a crashing procedure;

FIG. 4 shows a partial plan view of a sole plate of the portable circular saw of FIG. 1, having a third embodiment of a safeguard device;

FIG. 5 shows a partial plan view and a partial lateral view of the sole plate of the portable circular saw of FIG. 1, having a fourth embodiment of a safeguard device;

FIG. 6 shows a partial plan view and a partial lateral view of the sole plate of the portable circular saw of FIG. 1, having a fifth embodiment of a safeguard device;

FIG. 7 shows a partial plan view and a partial lateral view of the sole plate of the portable circular saw of FIG. 1, having a sixth embodiment of a safeguard device;

FIG. 8 shows a schematic front view of the portable circular saw of FIG. 7 when crashing into the workpiece;

FIG. 9 shows a partial plan view of the sole plate of the portable circular saw of FIG. 1, having a seventh embodiment of a safeguard device;

FIG. 10 shows a partial plan view and a partial lateral view of the sole plate of the portable circular saw of FIG. 1, having an eighth embodiment of a safeguard device;

FIG. 11 shows an enlarged illustration of a detail XI of FIG. 10;

FIG. 12 shows a partial plan view of the sole plate of the portable circular saw of FIG. 1, having a ninth embodiment of a safeguard device;

FIG. 13 shows a partial plan view of the sole plate of the portable circular saw of FIG. 1, having a 10^{th} embodiment of a safeguard device; and

FIG. 14 shows a partial cross section along the section line XIV-XIV of FIG. 13.

### DESCRIPTION OF THE EXEMPLARY EMBODIMENTS

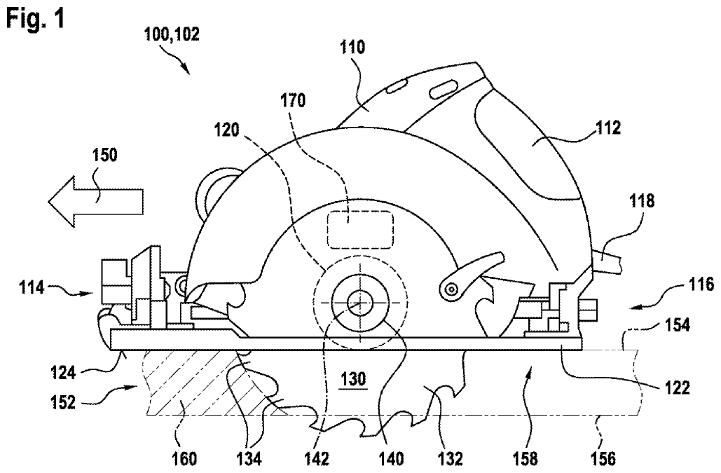

FIG. 1 shows a portable power tool 102 configured in an exemplary manner as a portable circular saw 100. Said portable circular saw 100 is preferably assigned an electromotive drive unit 120 which at least in portions is disposed in a housing 110. The housing 110 is preferably provided with an ergonomic handle 112 for a user.

The drive unit 120 preferably serves for driving a tool receptacle 144 for an interchangeable saw blade 130. The drive unit 120 herein is in particular configured for rotatingly driving the interchangeable saw blade 130 about an assigned rotation axis 142. The saw blade 130 is preferably configured as a circular saw blade 132 having a serrated cutting edge 134.

The portable circular saw 100 for the mains-dependent supply of power is preferably connected mechanically and electrically to a mains connector 118, but additionally or alternatively could also be equipped with a rechargeable battery pack for the mains-independent supply of power. The portable power tool 102, deviating from the illustration in FIG. 1, can also be configured as a table circular saw, a plunge saw, a sabre saw, or as any other electric power tool having a rotating saw blade and/or a saw blade that oscillates in an at least substantially linear manner.

The housing 110 of the portable circular saw 100 preferably has a first end 114 and a second end 116 that is directed away from the first end 114. The portable circular saw 100 herein is provided for sawing in an operating direction 150. A corresponding operating region 152 herein is preferably situated at the first end 114, or ahead of the saw blade 130 in the operating direction 150. Moreover, the portable circular saw 100 is preferably provided with an at least substantially planar, preferably rectangular, sole plate 122. The sole plate 122 has a bearing face 124 that is directed away from the drive unit 120 and with the aid of which the portable circular saw 100 is guidable, for example, along an at least substantially flat upper side 154 of a workpiece 160 which here is only indicated by a dotted line. In the case that no plunge cuts or insert cuts, respectively, are carried out with the portable circular saw 100, the saw blade 130 typically penetrates the workpiece 160 completely and therefore at least partially exits the workpiece 160 in the region of a lower side 156 of said workpiece 160.

A riving knife which for increasing the operational safety is usually provided in the case of conventional portable circular saws and which is guided through a saw cut 158 generated in the workpiece 160 by the portable circular saw 100 and by means of which jamming of the saw blade 130 is to be prevented, is not plotted here for the sake of improved clarity of the drawing. The portable circular saw 100 moreover usually has an optional pivoting protective hood. Corresponding pivoting protective hoods are well known from the relevant prior art, which is why a detailed description of the optional pivoting protective hood is prevented for the sake of simplicity and brevity of the description.

According to the invention, a safeguard device 170, preferably for further increasing the operational safety, is integrated in the portable circular saw 100, by means of which safeguard device 170 a crashing of the portable circular saw 100 into the workpiece 160 inter-alia is able to be detected and the drive unit 120 is able to be switched off and/or at least partially decelerated in a timely manner, or immediately, respectively. Furthermore, the end of a saw cut to be carried out as well as jamming of the saw blade 130 can optionally also be detected by means of the safeguard device 170, wherein the jamming of the saw blade 130 can lead to a dangerous so-called kickback. In both cases, the drive unit 120, preferably for increasing the operational safety of the user or operator, respectively, is switched off in a controlled, preferably immediate, manner by the safeguard device 170. In the case of the detection of the saw cut end, an at least partial deceleration of the drive unit 20 can also be provided.

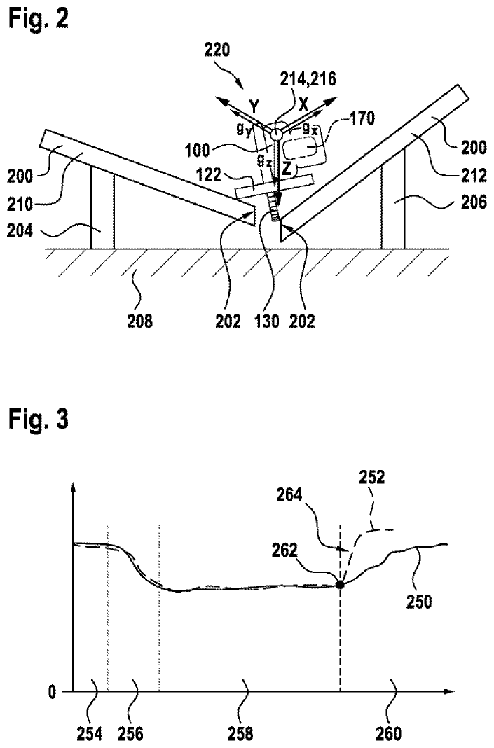

FIG. 2 shows the portable circular saw 100 of FIG. 1, having a first embodiment of the safeguard device 170 when crashing into a workpiece 200. The portable circular saw 100 for illustration purposes for generating a saw cut 202 is guided on a workpiece 200, wherein the workpiece 200 in an exemplary manner is self-supported on a first and a second counter bearing 204, 206 which are disposed so as to be mutually spaced apart on a hard ground 208. The two counter bearings 204, 206 can be, for example saw horses or the like. On account of the sudden crashing of the portable circular saw 100 into the workpiece 200 in the region of the saw cut 202, a first and a second fragment 210, 212 are recreated.

In order for the crashing of the portable circular saw 100 into the workpiece 200 to be reliably detected, the first embodiment of the safeguard device 170 has a sensor element 214 which here in an exemplary manner is implemented having a preferably electronic acceleration sensor 216. With the aid of the acceleration sensor 216, at least the linear acceleration of the portable circular saw 100 in the direction of a z-axis of a rectangular coordinate system 220, or in the direction of the floor 208, can be detected so as to detect the crashing procedure of the portable circular saw 100 into the workpiece 200, schematically illustrated here, with high reliability. On account of the crashing of the portable circular saw 100 into the workpiece 200, a significant acceleration g_{z} which is detectable by means of the acceleration sensor 216 and which for evaluation is transmitted to the safeguard device 170 is created primarily in the direction of the z-axis of the coordinate system 220, or in the direction of the hard ground 208, respectively.

By way of the safeguard device 170, the drive unit 120 of FIG. 1, which for the sake of improved clarity in the drawing is not illustrated here, can be switched off and/or at least partially decelerated when exceeding a predefined limit value for the acceleration g_{z}, on account of which the operational safety for the user of the portable circular saw 100 in the event of crashing can be considerably increased. Moreover, the safeguard device 170 can contain further acceleration sensors (not illustrated) so as to also detect the further linear acceleration components g_{xy} of the portable circular saw 100 in the direction of an x-axis and/or a y-axis of the three-dimensional orthogonal coordinate system 220, and by means of the safeguard device 170 enable an even more precise detection of a crashing procedure of the portable circular saw 100 into the workpiece 200.

Furthermore, the safeguard device 170 can have at least one gyro sensor, or an electronic angular acceleration sensor, respectively, (not illustrated for the sake of improved clarity in the drawing) as a further sensor element so as to additionally detect potential angular accelerations of the portable circular saw 100 about at least one of the three axes of the coordinate system 220 and thus tilting movements of the portable circular saw 100 and evaluate said angular accelerations by way of the safeguard device 170.

FIG. 3 shows a diagram of a rotating speed profile detected by a second embodiment of a safeguard device for detecting a crashing procedure. In the case of a second embodiment of a safeguard device (not illustrated in the drawings) said second embodiment has at least one rotating speed sensor for detecting a current rotating speed of the drive unit, or of the saw blade driven by the latter, respectively, (cf. Reference signs 120, 130 in FIG. 1). The rotating speed sensor can be implemented, for example, by means of a permanent magnet and a Hall effect sensor, or a reed relay, or else based on optics.

The diagram by means of a first curve profile 250, illustrated with a solid line, and of a second curve profile 252, plotted with a dashed line, illustrates the rotating speed of the current rotating speed of the saw blade, or of the drive unit of the portable circular saw, respectively, in each case as a function of the sawing progress, as determined by the rotating speed sensor and transmitted to the safeguard device for evaluation, wherein the rotating speed is plotted on the vertical axis and the sawing progress of the portable circular saw through the workpiece is plotted on the horizontal axis.

In a first region 254 of the two curve profiles 250, 252, the drive unit of the portable circular saw is idling, that is to say that the saw blade freely rotates at the usual idling rotating speed. In a second region 256 of the two curve profiles 250, 252, the saw blade increasingly enters a workpiece to be sawn until the latter is completely penetrated, and the rotating speed consequently steadily drops to an operating rotating speed that is usual in the normal sawing operation. In a third region 258 of the two curve profiles 252, 254 the portable circular saw is in the normal, or orderly, respectively, sawing operation, wherein the operating rotating speed remains almost constant. The two curves 250, 252 in the first three regions 254, 256, 258 of the diagram have practically identical profiles, or are almost mutually congruent, respectively.

In a fourth region 260 the first curve 250 however rises considerably slower in comparison to the sinking of the latter at the beginning of sawing in the second region 256, this indicating a delayed increase in the rotating speed of the saw blade when exiting the workpiece until the idling rotating speed is achieved again. By contrast, in the region of a transition between the third region 258 and the fourth region 260, in the region of a point 262 there is an abrupt, or comparatively steep, rise of the second curve 252, or of the rotating speed of the saw blade, respectively, which enables an unequivocal conclusion of crashing of the portable circular saw into the workpiece having taken place. The abrupt rotation speed increase 264 that can be measured directly after the crashing, is evaluated by the safeguard device and serves as an unequivocal signal for switching off and/or for at least partially decelerating the drive unit of the saw blade when a crashing procedure arises.

A saw cut end in the normal sawing operation is present and can be detected by means of the rotating speed sensor when the rotating speed increase of the drive unit corresponds to the profile of the second curve 250 in the fourth region 260 of the diagram such that the safeguard device can optionally initiate the switching off and/or the at least partial deceleration of the drive unit of the portable circular saw.

A practically abrupt drop in the second curve 252 to a rotating speed of approximately “0” (not illustrated) however indicates a total blockage of the saw blade within the workpiece to be sawn, which can arise, for example, on account of the saw blade tilting or the like. In order for the accident-prone kickback of the portable circular saw toward the user to be avoided in such a situation, the safeguard device can likewise initiate the immediate switching off and/or at least partial deceleration of the drive unit of the portable circular saw.

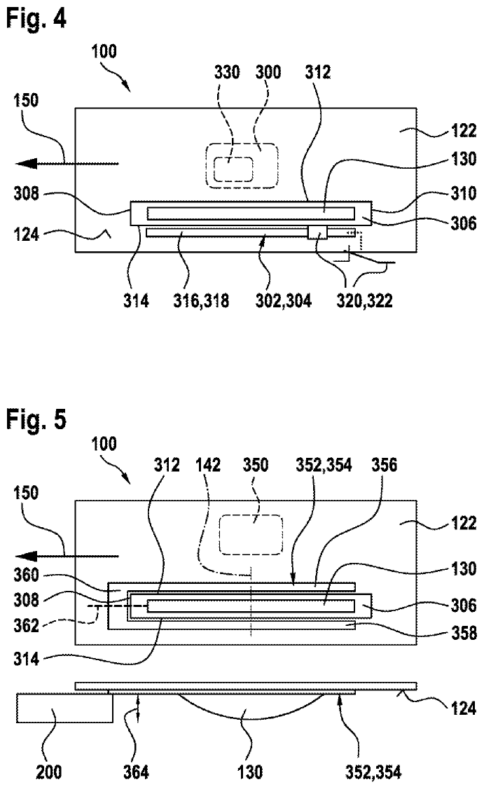

FIG. 4 shows a sole plate 122 of the portable circular saw 100 of FIG. 1, having a safeguard device 300 according to a third embodiment. The safeguard device 300 of the portable circular saw 100 preferably comprises a sensor element 302 which here in are purely exemplary manner is constructed having a rectangular, electromechanical and/or electronic switching means 304. The saw blade 130 of the portable circular saw 100 engages through a rectangular passage opening 306 of the sole plate 122, wherein the passage opening 306 has a first and a second narrow side 308, 310, as well as a first and a second longitudinal side 312, 314. The portable circular saw 100 herein in relation to the workpiece (not illustrated here) moves in the operating direction 150. The switching means 304 is preferably configured so as to be flush with the workpiece-facing bearing face 124 of the sole plate 122, and at least in portions runs along and so as to be slightly spaced apart and parallel with the second longitudinal side 314 of the passage opening 306 for the saw blade 130.

The switching means 304 can be implemented, for example, having a spring-loaded rocker 316, or having a spring-loaded pressure plate 318 which in the simplest case are coupled, for example, to an electrical contact 320 and/or a strain gauge 322, the signals thereof being in each case supplied to a control apparatus 330 within the safeguard device 300. The electrical contact 320 can be, for example, a simple electromechanical closing contact, an opening contact, or a two-way contact which is capable of being activated in a sensory or switching manner. In the case of the bearing face 124 of the sole plate 122 of the portable circular saw 100 not bearing on a workpiece to be sawn, or the switching means 304 not being mechanically stressed, respectively, said switching means 304 preferably does not terminate so as to be flush with the bearing face 124 of the sole plate 122, but springs out of the latter to a preferably minor extent and when non-stressed remains in this slightly proud position.

Should crashing of the portable circular saw 100 arise, the switching means 304 preferably springs out of the plane of the bearing face 124 of the sole plate 122 in the direction of the workpiece to be sawn such that the electrical contact 320 and/or the strain gauge 322 preferably emit an unequivocal electrical signal which can be evaluated by a control apparatus 330 of the safeguard device 300. When an electrical signal of this type that is generated by the switching means 304 arises, the safeguard device 300 preferably switches off the drive unit 120 of FIG. 1 of the portable circular saw 100 and/or at least partially decelerates said drive unit 120.

Alternatively or additionally, the rocker 316 or the pressure plate 318 of the switching means 304 can also have a permanent magnet (not illustrated) which when deflecting in the event of the portable circular saw 100 crashing in a non-contacting manner activates or releases a magnetic sensor such as, for example, a Hall effect sensor, a reed relay, or the like. The signal generated by the magnetic sensor in this instance preferably serves in turn for switching off and/or at least partially decelerating the drive unit 120 of FIG. 1 of the portable circular saw 100 by means of the safeguard device 300.

Alternatively, a second electromechanical and/or electronic switching means (not illustrated here) which in terms of construction is configured to be identical to the first switching means 304 can be provided in the region of the first longitudinal side 312 of the passage opening 306. The switching off and/or the at least partial deceleration of the drive unit 120 of FIG. 1 by the safeguard device 300 in such a situation can take place, for example, when both switching means in the event of a potential crashing procedure of the portable circular saw 100 lose the mechanical contact with the two fragments of the workpiece that are created in this instance.

FIG. 5 illustrates the sole plate 122 of the portable circular saw of FIG. 1 having a safeguard device 350 according to a fourth embodiment. The saw blade 130 again engages through the passage opening 306 of the sole plate 122 of the portable circular saw 100. The safeguard device 350 of the portable circular saw 100 again preferably comprises a sensor element 352 which preferably terminates so as to be completely flush with the bearing face 124 of the sole plate 122 of the portable circular saw 100, and which corresponding to the embodiment of FIG. 4 is constructed having an electromechanical and/or electronic switching means 354.

By contrast to the embodiment of FIG. 4, the switching means 354 preferably has an at least substantially U-shaped geometry that deviates from the rectangular shaping, having a first and a second leg 356, 358 which are connected by a base portion 360. The two legs 356, 358 of the switching means 354 herein are preferably oriented counter to the operating direction 150, while the base portion 360 lies in the operating direction 150. The switching means 354 moreover is configured so as to preferably be symmetrical with a central plane 362 of the saw blade 130 that typically runs perpendicularly to the sole plate 122, and in the event of the bearing face 124 bearing on the workpiece 200 terminates so as to be substantially flush with said bearing face 124. The two legs 356, 358 of the U-shaped switching means 354 preferably at least in portions and in each case slightly spaced apart run along the two longitudinal sides 312, 314 of the passage opening 306, while the base portion 360 preferably extends beyond the first narrow side 308 of the passage opening 306 and runs so as to be slightly spaced apart from said first narrow side 308.

Should crashing of the portable circular saw 100 arise, the switching means 354 is preferably released from the workpiece 200 and preferably springs out of the bearing face 124 of the sole plate 122, as is indicated by the double arrow 364, and generates a corresponding electrical signal within the safeguard device 350 such that the latter can switch off and/or at least partially decelerate the drive unit 120 of FIG. 1 of the portable circular saw 100. When the portable circular saw 100 is again brought to bear on the workpiece 200, the switching means 354 again preferably springs into the sole plate 122 so far that a termination that is as flush as possible with the bearing face 124 is ideally achieved. Instead of the one U-shaped switching means 354, a second U-shaped switching means (not illustrated here) can be provided which in relation to the switching means 354 is integrated in the sole plate 122 of the portable circular saw 100 so as to be mirror-symmetrical with the rotation axis 142 of the saw blade 130. The functional mode of the switching means 354 otherwise corresponds to that of the switching means of FIG. 4 such that, for reasons of brevity of the description, reference at this point is made to the explanations already offered there.

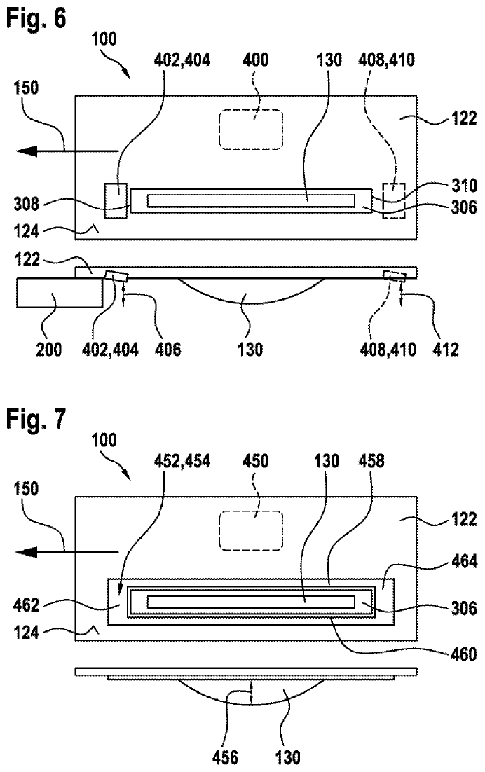

FIG. 6 shows the sole plate 122 of the portable circular saw 100 of FIG. 1 having a safeguard device 400 according to a fifth embodiment. The portable circular saw 100 having the safeguard device 400 preferably by means of the sole plate 122 is guided along the workpiece 200 in the operating direction 150. The saw blade 130 penetrates the passage opening 306. A sensor element 402 of the safeguard device 400 is preferably again constructed having an electromechanical and/or electronic switching means 404 which by contrast to the preceding embodiments is however positioned to a limited extent in the region of the first narrow side 308 of the passage opening 306 and which has a rectangular shape together with a comparatively small area. In the non-stressed state, the switching means 404 preferably springs out of the run-on face 124 of the sole plate 122, and the switching means 404 when running over, or contacting, respectively, the workpiece 200 ideally preferably springs into a position that is completely flush with the run-on face 124, wherein the two potential positions of the switching means are visualized by the double arrow 406.

Moreover, a further rectangular sensor element 408 which is implemented having a spring-loaded switching means 410 and the design embodiment thereof in terms of construction and the functional mode thereof corresponding to those of the switching means 404 can be placed on the second narrow side 310 of the passage opening 306 for the saw blade 130. Accordingly, the non-stressed switching means 410 springs at least partially out of the run-on face 124 of the sole plate 122 and when running over the workpiece 200 is pushed back into the sole plate 122 again such that the switching means 410 in this instance terminates as to be flush with said sole plate 122. The contraction and expansion of the spring-loaded switching means 410 herein is indicated by the double arrow 412. Should one of the switching means 404, 410 lose contact with the workpiece 200, this is an unequivocal indication that the portable circular saw 100 has crashed into the workpiece 200 to be sawn such that safeguard device 400 rapidly switches off and/or at least partially decelerates the drive unit of the portable circular saw 100.

FIG. 7 shows the sole plate 122 of the portable circular saw 100 of FIG. 1 having a safeguard device 450 according to a sixth embodiment. The portable circular saw 100 having the saw blade 130 that penetrates the passage opening 306 again moves in the operating direction 150 along the workpiece (not plotted here).

By contrast to the preceding embodiments, the safeguard device 450 has a sensor element 452 which is preferably formed having a frame-type, spring-loaded electronic and/or electromechanical switching means 454 which preferably comprises the passage opening 306 on all sides so as to be slightly spaced apart therefrom, or in the manner of a frame, respectively. In the non-stressed state of the switching means 454, the latter preferably springs out of the bearing face 124 of the sole plate 122, while said switching means 454 bearing on the workpiece (not illustrated here) as is indicated by the double arrow 456, preferably springs back into the sole plate 122 of the portable circular saw 100 again so as to terminate flush with the bearing face 124. In the event of these portable circular saw 100 crashing, the switching means 454 preferably springs out of the sole plate 122, and the safeguard device 450 immediately switches off the drive unit 120 of FIG. 1 of the portable circular saw 100 and/or decelerates said drive unit 120 at least partially. A first and a second longitudinal side 458, 450 of the switching means 454 herein are of significantly narrower dimensions than a first and a second narrow side 462, 464 of the switching means 454.

The functioning of the safeguard device 450 otherwise again corresponds substantially to that of the variants of embodiments of safeguard devices already described above such that, for reasons of brevity of the description, reference at this point is to be made to the relevant paragraphs of the description.

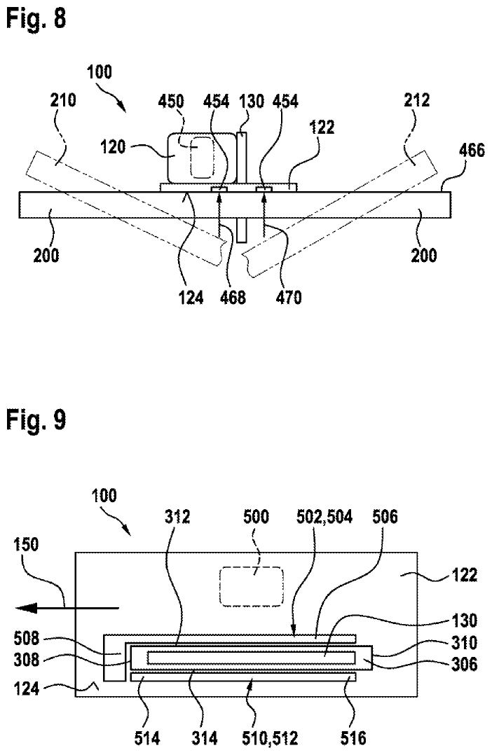

FIG. 8 shows the portable circular saw 100 according to FIG. 7 when crashing into the workpiece 200 of FIG. 5. The portable circular saw 100 by means of the bearing face 124 of the sole plate 122 for carrying out a desired saw is guided along an upper side 466 of the workpiece 200. In the normal sawing operation the spring-loaded frame-type switching means 454 of FIG. 7 preferably terminates so as to be flush with the bearing face 124 of the sole plate 122 of the portable circular saw 100. In this state, the switching means 454 preferably by the upper side 466 of the still intact workpiece 200 is impinged in the directions of the arrows 468, 470, counter to the spring effect of the switching means 454 which attempts to lift said switching means 454 out of the sole plate 122. Should the portable circular saw 100 crash in to the workpiece 200, the two fragments 210, 212 are created from the initial intact workpiece 200, wherein the mutual contact between the workpiece 200 and the frame-type switching means 454 is lost such that the switching means 454 of the safeguard device 450 preferably springs out of the bearing face 124 of the sole plate 122. On account thereof, the drive unit 120 of the portable circular saw 100, again controlled by the safeguard device 450, is immediately switched off and/or at least partially decelerated.

FIG. 9 shows the sole plate 122 of the portable circular saw 100 of FIG. 1 having a safeguard device 500 according to a seventh embodiment. The sole plate 122 of the portable circular saw 100 is again moved in the operating direction 150 in relation to a workpiece (not illustrated here). The safeguard device 500 preferably comprises a first sensor element 502 which here is formed having an at least substantially L-shaped first electromechanical and/or electronic switching means 504. A longitudinal leg 506 of the first switching means 504 at least in portions runs along so as to be slightly spaced apart from the first longitudinal side 312 of the passage opening 306, while a short leg 508 measured so as to be wider in comparison to the longitudinal leg 506 runs so as to be slightly spaced apart and in parallel with the first narrow side 308 of the passage opening 306 for the saw blade 130. Moreover, the safeguard device 500 preferably possesses a second sensor element 510 which here is implemented having a substantially rectangular, electromechanical and/or electronic switching means 512. The second, at least substantially elongate, rectangular switching means 512 herein at least in portions runs along and so as to be slightly spaced apart from the second longitudinal side 314 of the passage opening 306. A first end portion 514 of the second switching means 512 terminates so as to be flush with the narrow side 308 of the passage opening 306, while a second end portion 516 that points away from the first end portion 514 terminates slightly in front of the second narrow side 310 of the passage opening 306 and preferably so as to be flush with the longitudinal leg 506 of the first switching means 504.

Should crashing of the portable circular saw 100 into the workpiece (not illustrated here) arise, the release of only one of the two switching means 504, 512 from the workpiece, or the fragments thereof, suffices, wherein at least one of the switching means 504, 512 rises out of the bearing face 124 of the sole plate 122 so as to trigger the immediate switching off of the drive unit and/or the at least partial deceleration of the drive unit 120 of FIG. 1 by the safeguard device 500.

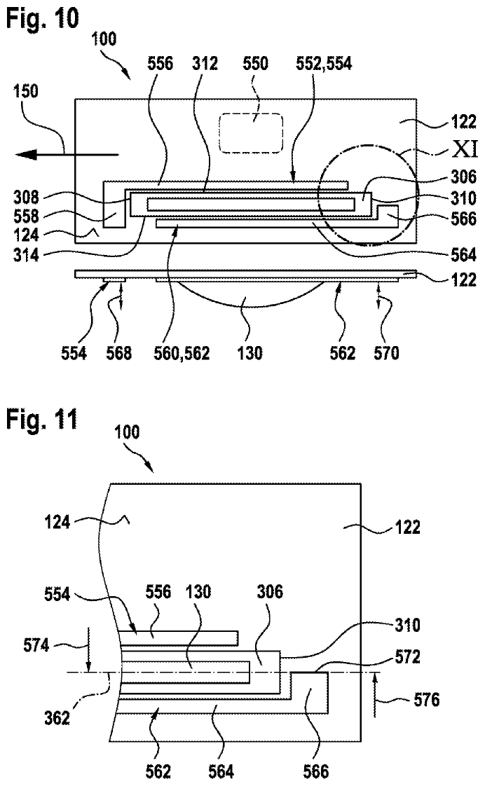

FIG. 10 shows the sole plate 122 of the portable circular saw 100 of FIG. 1 having a safeguard device 550 according to an eighth embodiment. The sole plate 122 of the portable circular saw 100 again moves in the operating direction 150 in relation to a workpiece (not illustrated here). The safeguard device 550 preferably comprises a first sensor element 552 which again is formed having an at least substantially L-shape first electromechanical and/or electronic switching means 554. The switching means 554 possesses a longitudinal leg 556 which in portions runs so as to be slightly spaced apart from the first longitudinal side 312 of the passage opening 306 for the saw blade 130. Furthermore, the switching means 554 has a short leg 558 which is configured so as to be orthogonal to the longitudinal leg 566 and which extends so as to be slightly spaced apart across the first narrow side 308 of the passage opening 306. A second sensor element 560 is preferably constructed having an at least substantially likewise L-shaped second electromechanical and/or electronic switching means 562. The second switching means 562 likewise possesses a longitudinal leg 564 which at least in portions runs so as to be slightly spaced apart from the second longitudinal side 314 of the passage opening 306. By contrast, a short leg 566 of the second switching means 562 only extends partially and so as to be slightly spaced apart along the second narrow side 310 of the passage opening 306 in the sole plate 122 of the portable circular saw 100.

Each of the two again spring-loaded switching means 554, 562, as is indicated by the two double arrows 568, 570, without contact with the workpiece preferably springs out of the run-on face 124 of the sole plate 122 and when the sole plate 122 bears on the workpiece (not illustrated here) is again pushed back into the sole plate 122 so as to be preferably completely flush therewith.

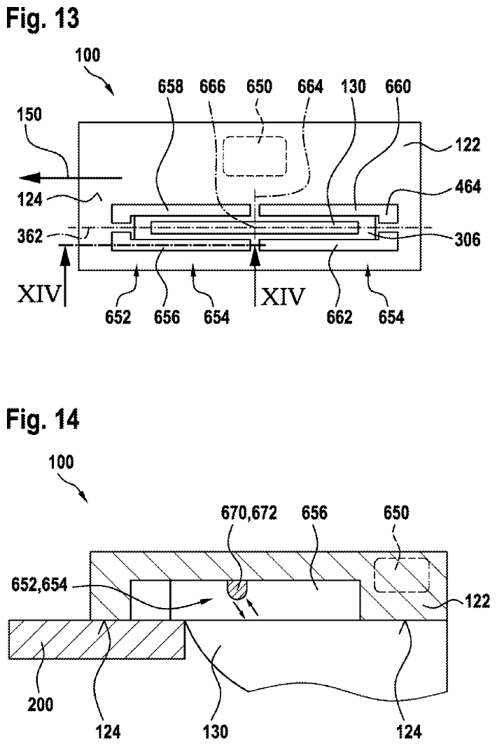

In the event of the portable circular saw 100 crashing into the workpiece (not plotted), at least one of the spring-loaded switching means 554, 562 preferably springs abruptly out of the sole plate 122, and the safeguard device 550 in response to a corresponding, preferably electrical, signal again triggers the immediate switching off and/or the at least partial deceleration of the drive unit 120 of FIG. 1 of the portable circular saw 100. In addition to the two L-shaped switching means 554, 562, two further L-shaped switching means which in terms of construction are at least substantially designed in a corresponding manner but are not illustrated here can be grouped circumferentially about the passage opening 306 of the sole plate 122, wherein a minor spacing remains in each case between two switching means that are in each case circumferentially directly adjacent (cf. to this end the geometric arrangement of the four L-shaped depressions according to FIG. 13).

FIG. 11 shows an enlarged illustration of a detail XI of FIG. 10. The longitudinal leg 556 of the first switching means 554 preferably terminates just short of the second narrow side 310 of the passage opening 306 in the sole plate 122 for the saw blade 130 of the portable circular saw 100. The short leg 566 preferably adjoins the longitudinal leg 564 of the second switching element 562 in an orthogonal manner, wherein the internal edge 572 of said short leg 566 runs parallel and flush with the central plane 362 of the saw blade 130, as is indicated by the arrows 574, 576. In the event of mechanical contact with the workpiece (not illustrated here) the switching means 554, 562 again preferably terminates so as to be flush with the bearing face 124 of the sole plate 122 of the portable circular saw 100.

Consequently, a particularly reliable detection of crashing of the portable circular saw 100 is possible, since the second switching means 562 extends approximately up to the center of a saw cut to be carried out with the portable circular saw 100.

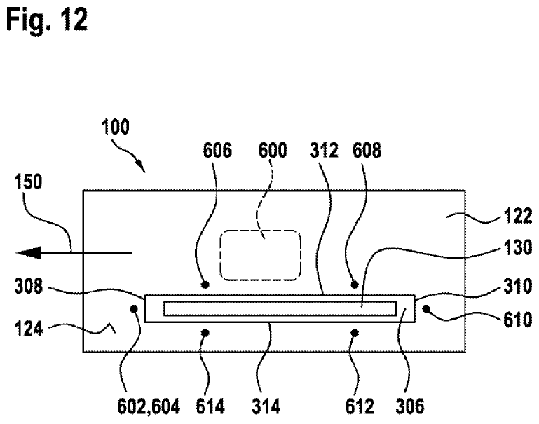

FIG. 12 shows the sole plate 122 of the portable circular saw 100 of FIG. 1 having a safeguard device 600 according to a ninth embodiment. The sole plate 122 of the portable circular saw 100 moves in the operating direction 150 along the workpiece (not plotted here). The saw blade 130 herein penetrates the passage opening 306 of the sole plate 122. The safeguard device 600 here preferably only comprises inter-alia in an exemplary manner six sensor elements of which for the sake of improved clarity in the drawing only one sensor element 602 is referenced so as to represent all others. Each of the six sensor elements is preferably formed having an optical detector 604, 606, 608, 610, 612 614, that operates in a non-contacting manner. The optical detectors 604 to 614 which act in a rather punctiform manner are preferably circumferentially grouped so as to be approximately uniformly spaced apart about the rectangular passage opening 306, and herein are sunk into the run-on face 124 of the sole plate 122 so as to be preferably flush therewith. A number and grouping of the optical detectors 604 to 614 that deviates here from is likewise possible.

The optical detector 604 here in only an exemplary manner is situated centrically in the region of the first narrow side 308 of the passage opening 306, while the optical detector 610 is positioned in the region of the second narrow side 310 of the passage opening 306. The optical detectors 606, 608 as well as 612, 614 in the region of the two longitudinal sides 312, 314 of the passage opening 306 are preferably disposed in each case in pairs in the sole plate 122 for the saw blade 130.

Should the sole plate 122 bear completely on the workpiece to be sawn, the optical detectors 604 to 614 are preferably shaded, and the portable circular saw 100 is in the normal sawing operation. However, should sudden crashing into the workpiece (not illustrated here) arise, each of the optical detectors 604 to 614 is typically at least briefly illuminated by the ambient light, and the safeguard device 600 by virtue of this temporal brightness transition which can be evaluated in a defined manner initiates the immediate switching off and/or the at least partial deceleration of the drive unit 120 of FIG. 1 of the portable circular saw 100. In principle, it is sufficient for one of the optical detectors 604, 610 to be in each case provided on both narrow sides 308, 310 of the passage opening 306. However, the reliability of the crash detection by means of the safeguard device 600 can be further optimized on account of the number of six optical detectors 604, 606, 608, 610, 612, 614 which are shown only in an illustrative manner in FIG. 12.

The detectors 604 to 614 can be implemented, for example, having passive optical elements which per se do not emit any electromagnetic radiation but only respond to the external ambient radiation. In this context, photo resistors, photodiodes, photo transistors, or the like can be used, for example. Alternatively or additionally to the purely passively acting optical detectors, active optical elements such as, for example, so-called optical reflex sensors, etc., can also be used, which per se emit electromagnetic radiation which in a situational manner is reflected by the workpiece and is then evaluated by the reflex sensor. The radiation emitted by the optical elements can be modulated for further optimizing the interference resistance.

FIG. 13 shows the sole plate 122 of the portable circular saw 100 of FIG. 1, having a safeguard device 650 according to a 10^{th} embodiment. The sole plate 122 of the portable circular saw 100 again moves in the operating direction 150 along the workpiece (not plotted here). The saw blade 130 having the central plane 362 penetrates the passage opening 306 of the sole plate 122. The safeguard device 650 here in an exemplary manner comprises four sensor elements of which for improved clarity in the drawing only one sensor element 652 is referenced so as to represent all the others. The four sensor elements for configuring an area measuring zone 654 are inter-alia formed in each case having a first, second, third, and fourth, in each case L-shaped depression 656, 658, 660, 662 of the sole plate 122 of the portable circular saw 100. The four depressions 656 to 662 preferably have in each case an at least substantially rectangular cross-sectional geometry. The two L-shaped depressions 656, 668 as well as the two L-shaped depressions 660, 662 here in are in each case positioned so as to be mirror-symmetrical with the central plane 362 of the saw blade 130, and the two L-shaped depressions 658, 660 as well as the two L-shaped depressions 656, 662 in turn are in each case sunk in the sole plate 122 so as to be mirror-symmetrical with a centerline 664 of the passage opening 306 that runs perpendicularly to the central plane 362 of the saw blade 130. The four depressions 656, 658, 660, 662 are thus disposed point-symmetrically in relation to an intersection point 666 between the centerline 664 of the passage opening 306 and the central plane 362, wherein a narrow spacing remains between in each case two circumferentially directly adjacent depressions 656, 658, 660, 662, said spacing not being referenced for improved clarity in the drawing.

At least one optical detector (not illustrated here) is preferably installed in each of the (here only exemplary) four L-shaped depressions 656, 658, 660, 662. The optical detectors herein are preferably attached in the depressions 656, 658, 660, 662 such that said detectors do not protrude beyond the run-on face 124 of the sole plate 122 but if at all terminates as to be flush with the run-on face 124 of the sole plate 122, wherein a fully planar bearing of the sole plate 122 on the workpiece to be sawn is ideally guaranteed (cf. Reference sign 200, FIG. 14). Should the portable circular saw 100 crash into the workpiece to be sawn, all optical sensors of the area measuring zone 654 are typically at least briefly exposed to the ambient light such that the safeguard device 650 in response to the signal can initiate the immediate switching off and/or the at least partial deceleration of the drive unit 120 of FIG. 1 of the portable circular saw 100 in order to protect the user from injury.

The area measuring zone 654 is derived by virtue of the preferably four L-shaped depressions 656, 658, 660, 662 which circumferentially adjoin one another and are disposed in the manner of a quadrant, having the at least one optical detector disposed in each case therein. The area measuring zone 654 comprises the passage opening 306 of the sole plate 122 in the manner of a frame such that a particularly reliable as well as non-contacting detection of a crashing procedure of the portable power tools 100 into the workpiece (not plotted here) is possible by means of the safeguard device 650.

Shapings that deviate from the L-shaped geometry of the depressions 656, 658, 660, 662 that are set forth herein only in an exemplary manner as well as a higher and/or lower number of the depressions 656, 658, 660, 662 within the sole plate 122 of the portable circular saw 100 can likewise be provided.

FIG. 14 shows a partial cross section along the section line XIV-XIV of FIG. 13. An optical detector 670 which here in a purely exemplary manner is designed as an active optical reflex sensor 672 is situated in the first L-shaped depression 656 as part of the area measuring zone 654 of FIG. 13. As opposed to a purely passive optical element such as, for example, a photoresist, a photodiode, phototransistor, or the like, an optical reflex sensor actively emits an electromagnetic radiation which is reflected by the workpiece 200. Said electromagnetic radiation that is optionally reflected from the workpiece 200 then is directed, for example, to a photodiode integrated in the optical reflex sensor, or a phototransistor, the signal there of then being further amplified by the safeguard device 650 and being evaluated, for example, for detecting a crashing procedure of the portable circular saw 100 in the workpiece 200. The electromagnetic radiation emitted by the optical reflex sensor can be, for example, in the spectral range visible to the human eye, or in the adjacent near infrared range.

The workpiece 200 here only partially covers the depression 656 in the sole plate 122 of the portable circular saw 100 such that the electromagnetic radiation emitted by the optical reflex sensor 672 is if need be partially reflected, and the optical reflex sensor 672 does not emit any relevant electrical signal, for example. In such a situation, a crashing procedure of the portable circular saw 100 in the workpiece 200 is present, such that the safeguard device 650 triggers the immediate switching off and/or the at least partial deceleration of the drive unit of the portable circular saw 100. However, should the workpiece 200 cover the depression 656 in a substantially complete manner, the electromagnetic radiation emitted by the optical reflex sensor 672 is almost completely redirected from the workpiece 200 to the optical reflex sensor 672 such that the latter emits a signal which indicates to the safeguard device 650 the normal sawing operation, for example.

Instead of the optical reflex sensor 672 that actively emits an electromagnetic radiation, the optical detector 670 can also be implemented having a purely passively acting optical element such as, for example, a photoresist, a photodiode, a phototransistor, or the like, which solely registers the incoming electromagnetic radiation from the environment and admits a corresponding electrical signal. The functional mode of the optical detector 670 in this instance corresponds to the functional mode of the passive optical detectors already described in the context of FIG. 12, such that for reasons of brevity of the description reference can be made at this point to the explanations already made there. Instead of the optical detector, at least one radar sensor can also be used for detecting the crashing of the portable circular saw 100 into the workpiece 200, for example.

After a rapid switching off and/or an and at least partial deceleration of the drive unit 120 of FIG. 1 of the portable circular saw 100 once initiated by the safeguard device 650, the renewed starting of said portable circular saw 100 is preferably possible only by the user activating a separate unlocking installation that is assigned to the portable circular saw 100. In order for the detection of the crashing of the portable circular saw 100 into the workpiece 200 to be further optimized, the sensor elements of the various embodiments of the safeguard devices mentioned in the context of the preceding description, in particular the linear acceleration sensors, the angular acceleration sensors (gyro sensors), the rotating speed sensor, the electromechanical and/or electronic switching means, as well as the passive or active optical detectors can be combined with one another in any number and/or in any arbitrary manner.

1. A portable circular saw comprising:
a sole plate configured for guiding the portable saw along a workpiece;
a housing;
a drive unit, at least portions of which are disposed in the housing, the drive unit assigned a tool receptacle configured to receive an interchangeable saw blade and to rotatingly driving the interchangeable saw blade about an assigned rotation axis; and
a safeguard device having at least one sensor element, the safeguard device configured for detecting crashing of the portable circular saw into the workpiece during a sawing procedure, and, upon detecting any crashing into the workpiece, the safeguard device is configured to decelerate and/or switch off the drive unit.

2. The portable circular saw as claimed in claim 1, wherein the sensor element has at least one acceleration sensor.

3. The portable circular saw as claimed in claim 1, wherein the sensor element has at least one rotating speed sensor.

4. The portable circular saw as claimed in claim 1, wherein the sensor element has at least one electromechanical and/or electronic switching mechanism means.

5. The portable circular saw as claimed in claim 4, wherein the at least one electromechanical and/or electronic switching mechanism is arranged on a workpiece-facing bearing face of the sole plate in a region of a rectangular passage opening of the saw blade.

6. The portable circular saw as claimed in claim 5, wherein at least portions of the at least one electromechanical and/or electronic switching mechanism runs in a region of at least one narrow side and/or at least one longitudinal side of the passage opening.

7. The portable circular saw as claimed in claim 6, wherein the at least one electromechanical and/or electronic switching mechanism is L-shaped, U-shaped, or rectangular.

8. The portable circular saw as claimed in claim 4, wherein the at least one electromechanical and/or electronic switching mechanism is configured as a frame defining the passage opening.

9. The portable circular saw as claimed in claim 5, wherein the at least one electromechanical and/or electronic switching mechanism is configured such that, when the sole plate bears on the workpiece, the at least one electromechanical and/or electronic switching element terminates flush with the bearing face of said sole plate, and when the sole plate is raised from the workpiece, the at least one electromechanical and/or electronic switching element springs out of said bearing face.

10. The portable circular saw as claimed in claim 6, wherein the at least one electromechanical and/or electronic switching mechanism includes at least one of an electrical contact and a strain gauge, and a spring-loaded rocker or pressure plate configured to activate the at least one of the electrical contact and the strain gauge.

11. The portable circular saw as claimed in claim 1, wherein the at least one sensor element has at least one optical detector.

12. The portable circular saw as claimed in claim 11, wherein the at least one optical detector is arranged flush with a workpiece-facing bearing face of the sole plate in a region of a passage opening of the saw blade.

13. The portable circular saw as claimed in claim 11, wherein the sole plate has a workpiece-facing bearing face with at least one depression for configuring an area-measuring zone, and the at least one optical detector is disposed in the at least one depression.

14. The portable circular saw as claimed in claim 11, wherein the at least one optical detector includes an optical reflex sensor.

15. The portable circular saw as claimed in claim 1, wherein the safeguard device has a control apparatus.
